(19) United States
(12) Patent Application Publication
(10) Pub. No.: US 2022/0326186 A1
(43) Pub. Date: Oct. 13, 2022

(54) Bullion Balance

(71) Applicant: Farshod Kayyod, Ferndale, MI (US)

(72) Inventor: Farshod Kayyod, Ferndale, MI (US)

(21) Appl. No.: 17/226,114

(22) Filed: Apr. 9, 2021

(51) Int. Cl. G01N 29/04; G07D 5/04

(52) U.S. Cl. CPC G01N 29/045; G07D 5/04

(57) ABSTRACT

An apparatus used to balance bullion for a Ping Test. The apparatus is placed on a flat surface. The bullion being tested is then placed in a balanced position on top of the device. The user then taps the now balancing bullion with an appropriate object. This causes a vibration to move through the bullion, which creates a sound that is unique to the physical properties of the bullion being tested. By listening to the sound, and comparing it with a known authentic, the user can determine if the bullion being tested sounds genuine, has anomalies, been altered, tampered with, or is a counterfeit. Any differences in the sound produced is a strong indication that the bullion needs further testing.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention disclosed herein generally relates to an apparatus and method that uses sound to authenticate the composition and purity of precious metals, including, but not limited to, Gold and Silver bullion bars, rounds, coins, and ingots.

### Description of the Related Art

Investment grade precious metal bars and rounds are produced in a variety of sizes, shapes, and purities. Bullion Bars are generally commercially available in weights from 1 troy ounce to over 1,000 troy ounces and normally take on the shape of a rectangular bar or ingot. Precious metal bars are more commonly larger than rounds and coins. Precious metal rounds generally have a cylindrical or coin shape and weigh around 1 troy ounce in weight, although rounds in weights up to 100 kilograms have been produced. Precious metal bars, rounds, coins, and ingots are bought, sold, and traded daily by and between private individuals, retail dealers, wholesalers, and refiners.

The high value of precious metals like Gold and Silver makes them ideal targets for theft, tampering, alterations, and counterfeiting. Conventional bars are typically formed en masse without any particular security features that can be used and trusted to identify a particular bar as legitimately authentic or belonging to a particular owner. Serial numbers that do sometimes appear on bars are seldom recorded for ownership identification purposes, and to date, there is no central global registry of ownership information to thwart theft. Conventional bullion bars are generally formed with flat sides, making drilling out the core and the insertion of inexpensive metal alloy slugs a common practice for counterfeiters that result in a bar of substantially diminished value. It is also common practice for a counterfeiter to use a completely different base metal and then plate the object with the targeted precious metals.

Gold and Silver have a distinctive “ping” sound when struck. This is a longstanding and simplified technique used to tell if a Gold or Silver bar is genuine or if it is a lead, tungsten, or other metal alloy counterfeit. The problem in the existing art is that there is no convenient way for a buyer or dealer to try to get a reliable and suitably repeatable (standardized), recognizable “ping” out of the multitude of shapes, sizes, and weights that Gold and Silver bars, rounds, and coins come in.

A ping test is typically conducted by balancing a coin on your fingertip and tapping the coin with another object that creates the distinctive “ping” sound. The person doing the test can then ping a known authentic and compare the sounds. If the sounds are different the coin is likely a counterfeit, has anomalies, or has been tampered with in some way. If the sound is much different than the known authentic, the person conducting the test knows to continue testing the item in more ways. Producing a sufficient “ping” on large bullion is not as easily accomplished due to the larger physical characteristics and various configurations that Gold and Silver bars, rounds, coins, and ingots come in.

A number of devices and apparatuses are intended to identify and/or distinguish coins and other small discrete objects. One example is a coin counting and handling device, (such as those described in U.S. patent application Ser. No. 08/255,539, now U.S. Pat. No. 5,564,546, and its continuation application Ser. Nos. 08/689,826, 08/237,486, now U.S. Pat. No. 5,620,079 and its continuation Ser. No. 08/834,952, filed Apr. 7, 1997, and Ser. No. 08/431,070, all of which are incorporated herein by reference.) Other examples include vending machines, gaming devices such as slot machines, bus and subway tokens, “fare boxes,” and the like. For such purposes, the sensors provide information which can be used to discriminate coins from non-coin objects, different coin denominations, and also distinguish coins of one country from those of another.

A digital advancement in a similar field is Pingcoin. Which is the digital version of the classical “ping test” for identifying counterfeit coins. By recording and analyzing the sound produced by your coins with prerecorded sounds in a database, the app is able to tell you if the coin you're testing is genuine or fake.

It is oftentimes desirable in the sorting of coins to distinguish between real coins and fake coins. There are multiple solutions that have been presented in prior art. However, those solutions are limited and restricted to their conventional architecture, installation systems, and have considerable shortcomings which adversely effect the convenience with which they can be used. The prior systems have certain limitations including the design of their assemblies, technical usage, and costs which make them not suitable for every type of user.

It has to be noted that this proposed invention, The Bullion Balance, is an assembly for the advancement and ease of preforming the Ping Test with Gold and Silver bars, rounds, coins, and ingots. The Bullion Balance allows a user to quickly test and reliably authenticate their precious metals and bullion. The user balances the metal they are testing on top of the device and then taps it with another object. The tap creates a vibration in the bullion which then creates a sound that is unique to the physical properties of that bullion. The user can then compare this sound with the sound of a known authentic. If the sound from the object being tested has a different tone, pitch, resonance, or duration than the sound of the known authentic, the user knows the bullion being tested has been tampered with, has anomalies, or is a counterfeit and further testing should be done before confirming the item is authentic.

Other known prior art patents are US00187936 a coin balancing device with an off center fulcrum that uses a coin's known weight for the detection of counterfeit coins, US009934639 a method for magnetic detection of anomalies in precious metals, US010417855 a sensor system defining a sample region for detecting fake or altered bullion coins and metals, US005551542 a rotating coin identifier and separating device US20150308983, a transducer that vibrates a material to its natural frequency and collects the amplitude response and compares with a reference data set.

None of the previous inventions and patents, taken either singly or in combination, is seen to describe this invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to this invention and is not intended to be a full description. A full appreciation of the various aspects of the invention can be gained by taking the entire specification, claims, drawings, and abstract as a whole.

The primary desired objective of the presented invention is to provide a novel and improved method to conduct the Ping Test with bullion bars, rounds, coins, and ingots.

The objective of this invention is to provide an advanced methodology where the user will place the bullion they are testing on top of the device in a balanced position. The user will then tap the bullion with an external object to create and then verify the sound produced from the balancing bullion.

Another objective of this invention is to provide a user with a new and improved device and process that allows users to test their precious metals at home and determine if they have counterfeit products.

Another objective of the invention is for the main assembly to have a wide base with added grip to prevent sliding, a short stature to reduce the risk of the bullion falling from a high height, a narrow top for minimal contact area with the item being tested, and may include an added top pad made of rubber, silicone, fabric or other material, or combination of materials that makes contact with the bullion which reduces the risk of the bullion falling and also reduces any scratch risk from making contact with the device.

It is another objective to provide a reliable construction which is suitable for all shapes, sizes, and weights of bullion bars, coins, rounds, and ingots. Whether the item being tested is Gold, Silver, Copper, Brass, Aluminum, Steel or any other metal, precious or non-precious, the user will be able to conduct the ping test with this apparatus.

It is another objective to have a raised rim or lip around the edge of the device that safely catches coins if they are struck out of the balancing position. This rim or lip prevents coins from falling and rolling away. The coin is safely caught on the device.

The invention as per its further embodiments helps the user distinguish and determine potential counterfeits from known authentic bullion bars, rounds, coins, or ingots while mitigating the risk of damaging their appearance.

It is a further aspect of the present invention to provide a new and improved methodology for the ping test which is reliable and has sustained its results under various circumstances.

Thus, the objective of the device is to provide a new and improved method of testing bullion bars, coins, rounds, and ingots while mitigating the potential risk of damage during a ping test. Other advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 shows the top and side view of the invention.

FIG. 200 shows a practical demonstration of the ping test with a bullion bar.

FIG. 300 shows the edge of the device safely catching a coin that has fallen from the balanced position.

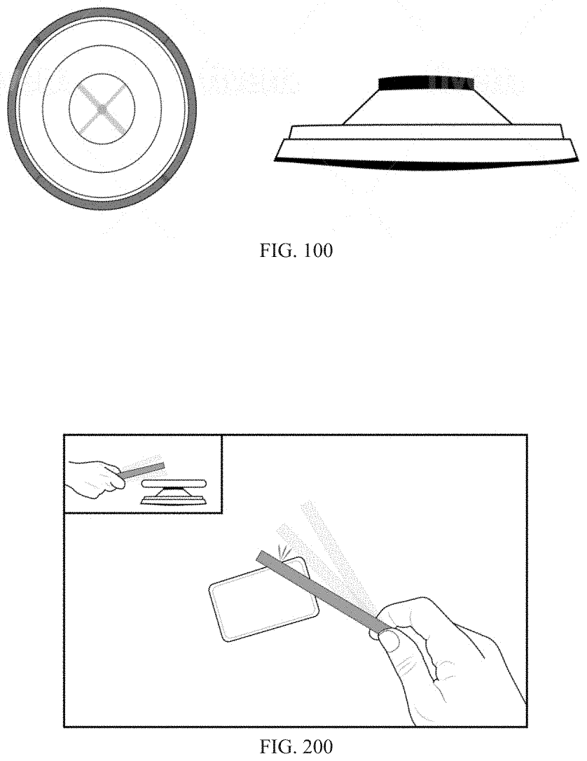

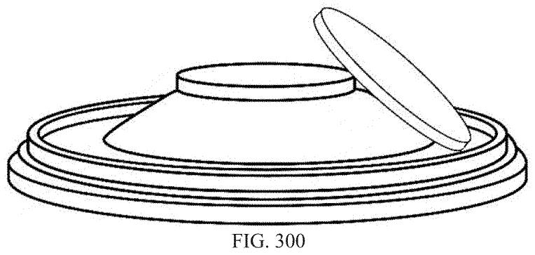

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the presented invention may be embodied in various forms. Therefore, specific details disclosed herein are not to be interpreted as limiting in scope, but rather as a basis for the claims, and as a representative basis for teaching one that is skilled in the art how to use the presented invention in an appropriately detailed system, structure, and manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The presented invention is directed to provide an improved methodology of ping testing bullion bars, ingots, rounds, and coins. It is also intended to do so in a way that will mitigate the risk of potential damage from the Ping Test.

Precious metals or bullion, as used herein, are investment grade metals that are commonly bought, sold, or traded in the form of cast, extruded, stamped bars and rounds, including, but not limited to, the metals Gold, Silver, Platinum, Palladium, and Copper.

One easy way to determine if bullion is authentic or counterfeit is by comparing the weight and dimensions of a known authentic with the weight and dimensions of the bullion in question. Gold and Silver are extraordinarily dense metals—much denser than just about any other base metal. That means just about all fakes that weigh the correct amount will be larger than the authentic. Often times they are made underweight in order to achieve the correct dimensions. Simply comparing the diameter, thickness, and weight of a potential counterfeit with bullion that is known to be genuine could be enough to put you at ease.

However, in the case of Gold, a Tungsten core is commonly used. Counterfeits can be made to the correct dimensions and weight with a Gold plating. In these cases the Ping Test is a very reliable method as a follow up to the dimensions and weight test.

To conduct a Ping Test, typically, a consumer will balance a coin on their fingertip and strike the coin with an external object causing the coin to ping. Authentic Gold and Silver have a unique resonant tone when struck and the difference is noticeable when comparing to other metals. The ping test is a very quick and reliable method to test for counterfeits. A known authentic has its own unique physical properties and when pinged it makes a sound that is unique to those physical properties. If a user gently strikes the potential counterfeit and the sound is much different than the known authentic, the user then knows it has been tampered with, altered in some way, has anomalies, or is a counterfeit. In any of these cases, if the sound is different, the user should do additional testing methods to verify the item in question.

The typical approach of balancing larger bullion on your fingertip to conduct a Ping Test is very difficult to do, especially when attempting to Ping larger bullion bars, ingots, rounds, and coins that can weigh between 10 Troy Ounces to over 1,000 Troy Ounces (68.5 lbs.) Not only is it difficult, it also puts the bullion at a high risk for fall damage.

This presented invention, as per its preferred embodiments, is an assembly that is placed on a flat surface and used as a balance point for the bullion item to rest on while the Ping Test is being conducted. The assembly has a wide base with grip to prevent the assembly from sliding during the test, a short stature to reduce the risk of the bullion falling from a high height, a narrow top for minimal contact area with the item being tested, and an added pad made of rubber, silicone, fabric or other material, or combination of materials that makes contact with the bullion which allows for more resonance to occur, mitigates scratch damage, as well as reducing the chances of the bullion falling.

First, the user will place the Bullion Balance onto a flat and stable surface. Next, the user will place the bullion item they are testing carefully centered on top of the bullion balance. The bullion, now in its balanced state, is then tapped with an appropriate external object, like a plastic rod or hardwood pencil for instance. This contact from the wood pencil causes a vibration in the bullion being tested which then creates a sound that is unique to the physical properties of that item being tested. The user can then compare the sound heard with the sound produced from a known authentic.

If the sound of the item being tested is much different than the sound of the known authentic, the user then knows the item being tested has anomalies, been altered, tampered with, or is a counterfeit. Any significant difference in the sound of the Ping Test is a very strong indication that the item being tested needs to go through other testing methods before being considered genuine or authentic.

While a specific embodiment has been shown and described, many variations are possible. With time, additional features may be employed. The particular shape or configuration of the platform or the interior configuration may be changed to suit the system or equipment with which it is used.

Having described the invention in this detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together with various embodiments for the purpose of streamlining the disclosure. This method of the disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A device and system that is used for Ping Testing bullion bars, rounds, coins, or ingots comprising of:
The apparatus being placed on a stable flat surface.
The apparatus having a wide base, short stature, and narrow top.
The narrow top of the apparatus has a soft pad made of rubber, silicone, fabric or other material, or combination of materials that makes contact with the item being tested.
The bullion being tested is placed on the top of the device in a balanced position.
The user then taps the now balancing bullion with an external object. The tap causes a vibration to move through the bullion, which then creates a sound that is unique to the physical properties of that bullion being tested.
The user closely listens to the sound the bullion is making and can determine its authenticity.

II: The invention comprising of the raised lip or rim around the outer edge of the base of the device which catches a coin that is struck too hard and knocked out of the balanced position during the Ping Test.
